(19) United States
(12) Patent Application Publication
(10) Pub. No.: US 2013/0189047 A1
(43) Pub. Date: Jul. 25, 2013

(54) Low Torque Tension Relief System for Threaded Fasteners

(71) Applicant: Michael James Psimas, Milton, GA (US)

(72) Inventor: Michael James Psimas, Milton, GA (US)

(73) Assignee: INTEGRA SERVICES TECHNOLOGIES, INC., Pasadena, TX (US)

(21) Appl. No.: 13/353,649

(22) Filed: Jan. 19, 2012

(51) Int. Cl. F16B 31/00

(52) U.S. Cl. 411/14.5

(57) ABSTRACT

A low torque tension relief system for threaded fasteners comprises an inner body with two sloped surfaces, upper and lower wedges which convert longitudinal movement of the inner body to a dimension change in the transverse direction, an outer body which acts to inhibit said movements, and a restraining bolt which passes through the outer body and engages the inner body thereby anchoring said inner body with said outer body and selectively restricting or promoting relative movement of said inner body compared to said outer body.

### FIELD OF THE INVENTION

The present invention relates to a low-torque tension relief system for threaded fasteners. More specifically, the present invention relates to the use of inclined sliding planes and a restraining screw to selectively eliminate the tensile load in a bolt or stud.

### BACKGROUND OF THE INVENTION

Galling is a common complication that arises when fastening or disassembling threaded components. Galling can result in damage to the threaded features or seizing of said components. Such damage or seizing can often be costly to repair or remedy. Galling is a form of adhesive wear and material transfer between metallic surfaces during operations in which relative motion of said surfaces is involved. The fastening of threaded components, in which interlocking threaded features are slid past each other under high loads, is an industrial operation which is notably prone or vulnerable to galling. Galling is a major concern in said application because the same features which promote galling, such as material ductility, metal on metal contact, friction, and high compressive loads, are not only present, but are indeed necessary features for operation.

However, galling can also occur at relatively low loads since localized pressure and energy density are greater than their respective macroscopic values. It is these local values which can result in elevated friction, promote material transfer, and induce phase transition. When two metallic surfaces, such as complimentary screw threads, are forced together, the high points or asperities found on each surface are the initial mating points. It is possible for said asperities to penetrate the opposing surface upon application of relative movement, thereby initiating plastic deformation and frictional forces between said surfaces. The induced pressure is highly localized, and the small region upon which the pressure is applied is termed the contact zone. As consequences of the pressure elevation, friction heating and adhesive forces increase, thereby resulting in initiation of material transfer, creation of additional protrusions, and growth of said protrusions. Furthermore, galling is especially likely when disassembling threaded fasteners which have been in service for several years due to additional debris from local oxidation, foreign contaminants, and the breakdown, seepage, and removal of assembly lubricants.

The high ductility of commonly used machine screws can be considered a requisite characteristic for substantial material transfer and galling. Frictional heating is greatly related to the size, shape, and material properties of the plastic zones that surround the penetrating objects. Correspondingly, brittle fractures rarely generate copious amounts of heat due to the small, transitory plastic zones. If the height of the protrusion grows larger than a critical threshold value, it may penetrate the brittle oxide layer of the complimentary mating surface. As a result, said protrusion could cause damage to the ductile bulk material on which the oxide layer originally formed, thus creating a region of plastic flow around said protrusion. Thus, the geometry, loading conditions, and relative motion of the protrusion govern the material flow, contact pressure, and thermal profile during sliding.

In the dynamic sliding contact of nut torqueing, increasing axial compressive force is proportionally equal to a rise in potential energy and thermal energy in the aforementioned localized system. Thus, the high loads and relative rotation associated with the torqueing of threaded nuts onto and off of threaded counterparts are particularly susceptible to galling. Additionally, as the nut is turned further and sliding progresses, additional energy is supplied to the system. Initially there is limited energy loss in the system (contact zone) since heat conduction away from the contact zone is significantly inhibited by the relatively small cross sectional area for thermal transport, and correspondingly low conductance, on the system boundary. The result is a corresponding increase in energy density and temperature in the contact zone, and said energy accumulation can damage the contact surfaces and alter their plastic behavior. Furthermore, the combination of direct contact and plastically deforming flow fields can result in the constitution of a common plastic zone in which the high energy density, pressure, and temperature promote inter-surface bonding. Generally, this greatly increases apparent adhesion as well as the force needed for further nut advancement or removal. In some cases this can cause seizing of the nut onto the threaded component, and removal of said nut requires time-consuming or destructive techniques such as cutting of the nut or screw. Reducing or eliminating the compressive load between threads greatly reduces the likelihood of galling due to a decrease in localized potential energy and frictional heating in the system.

One possible method of galling prevention is the use of a tensioning system to stretch the bolt before turning the nut off. Examples of such tensioning systems include hydraulic bolt tensioners and hydraulic nuts. However, the use of such systems can be time intensive and often require additional hydraulic machinery to produce the requisite operating pressures. Furthermore, said tensioning methods involve temporarily increasing the compressive load on the bolted component during disassembly, which may be undesirable in some circumstances. Examples of hydraulic tensioning devices can be found in U.S. Pat. Nos. 4,998,453; 5,527,015; and 7,673,849.

Another possible method of galling prevention is the use of a plurality of jackbolts to mechanically tension and unload the main stud or bolt. Contrary to the previously described hydraulic tensioning systems, this method has the advantage of not necessitating an increase of the compressive load on the bolted components during disassembly. However, this method of disassembly can be time intensive since multiple jackbolts must be unloaded for each main stud, often employing an iterative, step-wise unloading scheme. Examples of multiple jackbolt devices can be found in U.S. Pat. Nos. 3,618,994; 4,338,037; and 4,622,730.

There is therefore a need for a tension relief system which obviates the aforementioned problems.

### OBJECTS OF THE INVENTION

Accordingly, an object of this invention is the prevention of galling threaded features during the disassembly of bolted assemblies by reducing the load on said threaded features prior to disassembly.

Another object of this invention is the reduction of the load on the aforementioned threaded features without a corresponding increase of the axial tensile bolt load.

An additional object of the invention is to increase the speed of disassembly of bolted assemblies by eliminating the need for hydraulic machinery and the slow processes of torqueing or tensioning.

Another object of the invention is to increase the speed of the unloading process of bolted assemblies by requiring manipulation of only a single threaded restraining bolt which requires a lower torque than the main stud or bolt.

Other objects and advantages of the present invention will become obvious to the reader upon an understanding of the illustrative embodiments about to be described or will be indicated in the claims, and various advantages not referred to herein will occur to one skilled in the art upon employment of the invention in practice.

### BRIEF SUMMARY OF THE INVENTION

To attain these and other objects which will become more apparent as the description proceeds according to one aspect of the present invention, there is provided a low-torque tension relief system.

More specifically, in accordance with the present invention, there is provided a tension relief system for threaded fasteners (FIGS. 1 to 5) comprising an upper wedge (3), a wedge-shaped inner body (4), a lower wedge (5), an outer body (10), a top sliding plane (9) created by the interface of the upper wedge (3) and the inner body (4), a bottom sliding plane (12) created by the interface of the lower wedge (5) and the inner body (4), and a restraining bolt (11). The restraining bolt (11) passes through the outer body (10) and engages the inner body (4) via the threaded hole (14) of said inner body. The top wedge (3) also includes a hole (16) in its body through which a main bolt or stud may pass.

There is also provided a tension relief system (FIGS. 6 to 13) combined with a threaded bolt (1) with an integrated bolt head (8) and a threaded nut (2) to clamp a top work piece (6) and a bottom work piece (7) together. The tension relief system comprises an upper wedge (3), a wedge-shaped inner body (4), a lower wedge (5), an outer body (10), a top sliding plane (9) created by the interface of the upper wedge (3) and the inner body (4), a bottom sliding plane (12) created by the interface of the lower wedge (5) and the inner body (4), and a restraining bolt (11). The restraining bolt (11) passes through the outer body (10) and engages the inner body (4) via the threaded hole (14) of the inner body. The tensile load in the main bolt (1) acts through the top work piece (6) and the nut (2) to compress the upper wedge (3) and the lower wedge (5) of the tension relief system. Movement of the upper wedge (3) and the lower wedge (5) is inhibited by the outer body (10) and the inner body (4) which are anchored together by the restraining bolt (11); thus, the tensile load in the main bolt (1) is transferred to the restraining bolt (11). The wedge-like shape of the inner body (4) acts as an inclined plane, thereby lowering the tensile load on the restraining bolt (11) compared to the main bolt (1). To activate the tension relief system, the restraining bolt (11) is loosened, allowing the inner body (4) to move away from the outer body (10) by sliding along the top sliding plane (9) and the bottom sliding plane (12). This, in turn, allows the upper wedge (3) and the lower wedge (5) to move towards each other, thereby creating a gap (13) between the nut (2) and the upper wedge (3) and reducing the tensile load in the main bolt (1). The reduction of the tensile load in the bolt (1) corresponds to a reduction in the forces on the threaded features of the nut (2) and the main bolt (1); thus, the bolted assembly may be disassembled with minimal risk of galling.

There is also provided an embodiment with multiple tension relief systems (FIGS. 14 to 15) combined with threaded bolts (1) and threaded nuts (2) to clamp common flanges (15) together. The tension relief systems each comprise of an upper wedge (3), a wedge-shaped inner body (4), a lower wedge (5), an outer body (10), a top sliding plane (9) created by the interface of the upper wedge (3) and the inner body (4), a bottom sliding plane (12) created by the interface of the lower wedge (5) and the inner body (4), and a restraining bolt (11). The restraining bolt (11) passes through the outer body (10) and engages the inner body (4) via the threaded hole (14) of the inner body. The upper wedge (3) also includes a hole (16) extending through the body through which a main bolt or stud may pass.

Other aspects and advantages will be more readily apparent as the present invention becomes better understood by reference to the following detailed description and considered in connection with the accompanying drawings in which like reference symbols designate like elements throughout the figures.

The features of the present invention which are believed to be novel are set forth with particularity in the appended claims.

### BRIEF DESCRIPTION OF THE SEVERAL VIEWS OF THE DRAWING

FIG. 1 is an isometric view showing the tension relief system assembly according to an embodiment of the present invention.

FIG. 2 is a side view of FIG. 1 showing the alignment of various parts.

FIG. 3 is a top view of FIG. 1 showing the hole through which the main stud or bolt may pass.

FIG. 4 is a front view of FIG. 1 showing the restraining bolt.

FIG. 5 is a full section view of FIG. 1 showing internal mating of the restraining bolt and inner body of the tension relief system assembly.

FIG. 6 is an isometric view of a tension relief system with a bolted assembly including a headed bolt, a nut, and two clamped work pieces.

FIG. 7 is a side view of FIG. 6 showing a tension relief system with a bolted assembly including a headed bolt, a nut, and two clamped work pieces.

FIG. 8 is a front view of FIG. 6 showing a tension relief system with a bolted assembly including a headed bolt, a nut, and two clamped work pieces.

FIG. 9 is a full section view of FIG. 6 showing a tension relief system with a bolted assembly including a headed bolt, a nut, and two clamped work pieces.

FIG. 10 is an isometric view of an activated tension relief system with a bolted assembly including a headed bolt, a nut, and two work pieces.

FIG. 11 is a side view of FIG. 10 showing an activated tension relief system with a headed bolt, a nut, two clamped work pieces, and a gap between the nut and upper wedge.

FIG. 12 is a front view of FIG. 10 showing an activated tension relief system with a headed bolt, a nut, two clamped work pieces, and a gap between the nut and upper wedge.

FIG. 13 is a full section view of FIG. 10 showing an activated tension relief system with a bolted assembly and a gap between the nut and upper wedge.

FIG. 14 is an isometric view of multiple tension relief systems with a bolted assembly including headed bolts, nuts, and two clamped circular flanges.

FIG. 15 is a top view of FIG. 14 showing multiple tension relief systems with a bolted assembly including headed bolts, nuts, and two clamped circular flanges.

### DETAILED DESCRIPTION OF THE INVENTION

With reference to the annexed figures, the preferred embodiments of the present invention will be herein described for indicative purposes and by no means represent limitations.

The figures and description attached to it are only intended to illustrate the idea of the invention. As to the details, the invention may vary within the scope of the claims. So, the size and shape of the tension relief system may be chosen to best fit the fastened assembly.

Also, as used hereinabove and hereinafter, the term “stud” generally refers to stud, bolt, rod and other similarly shaped fasteners used in securing assemblies.

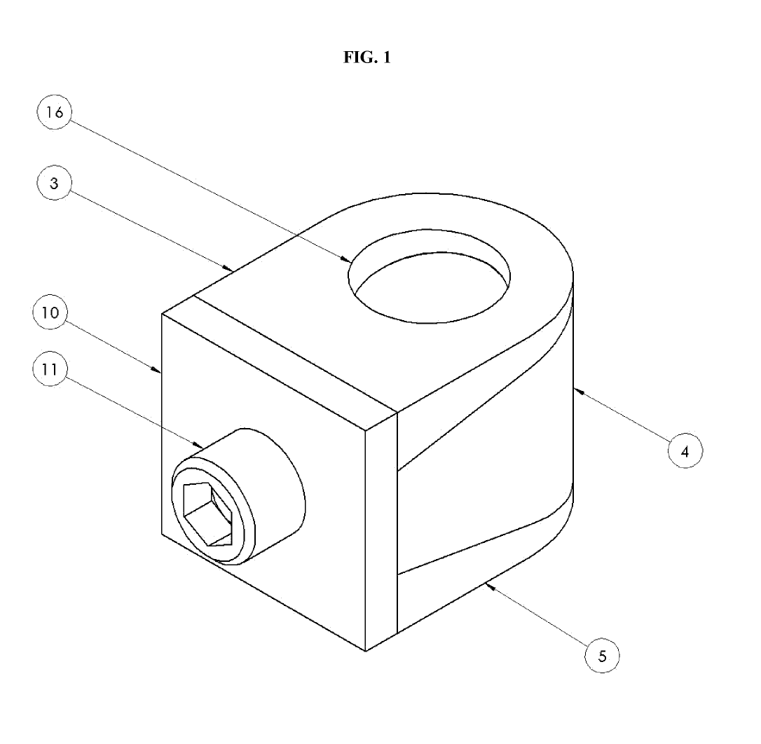

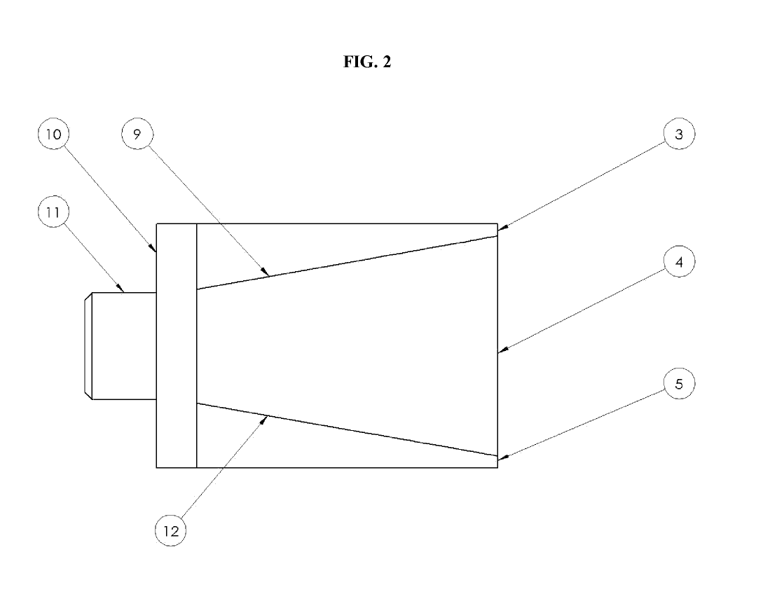

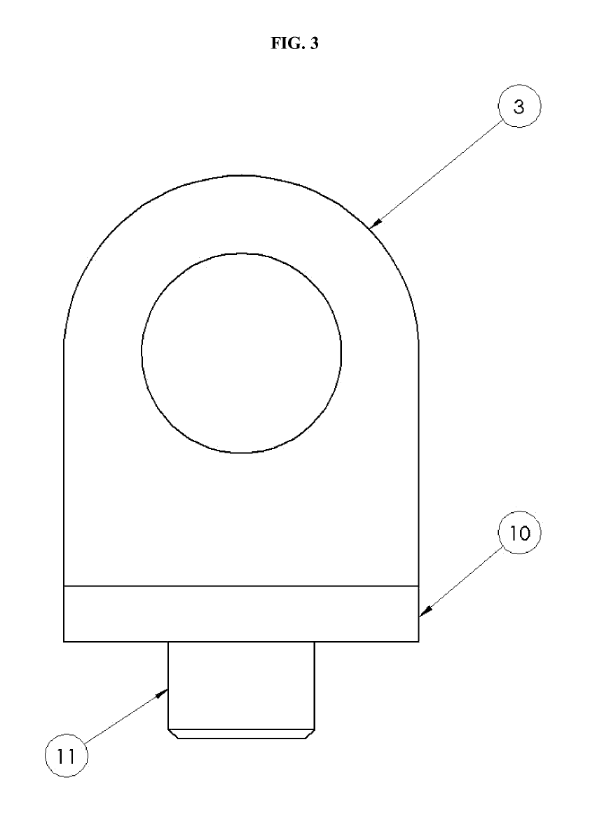

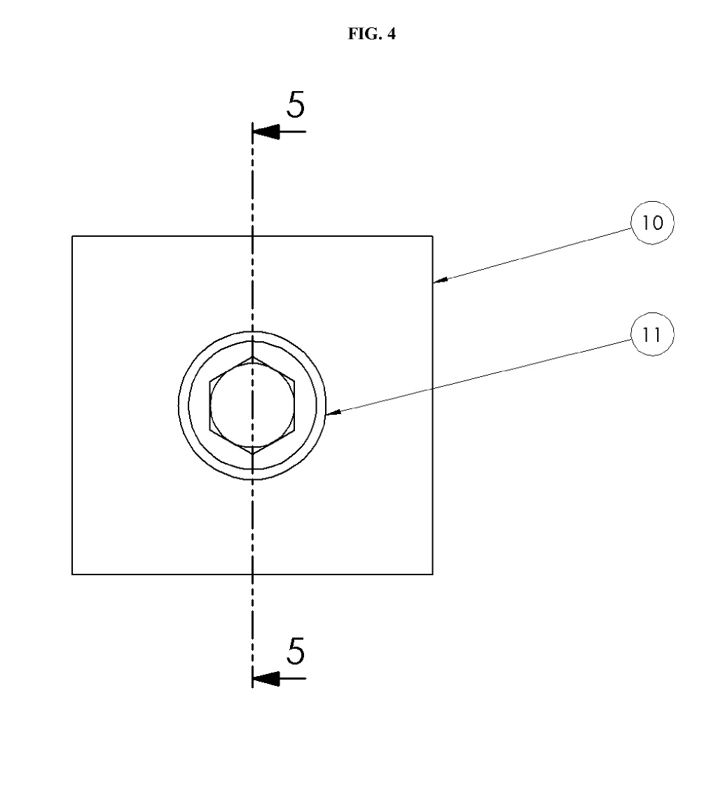

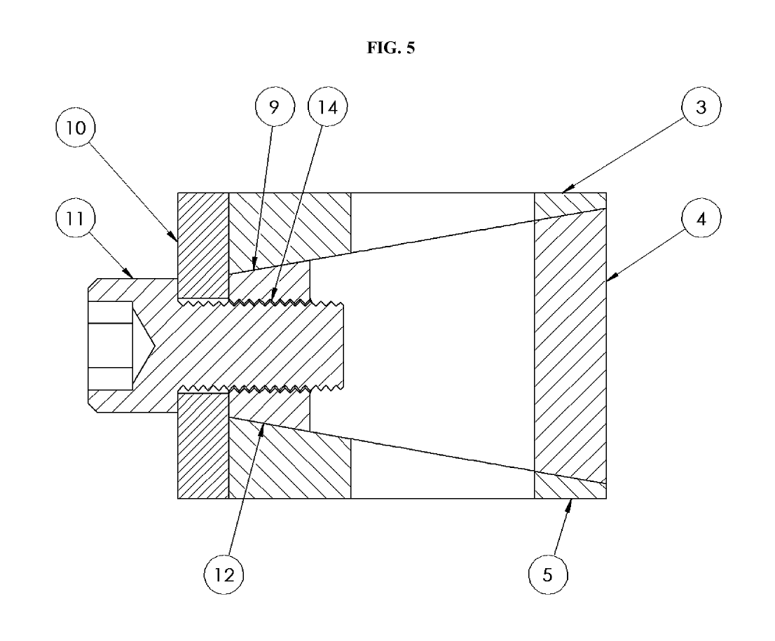

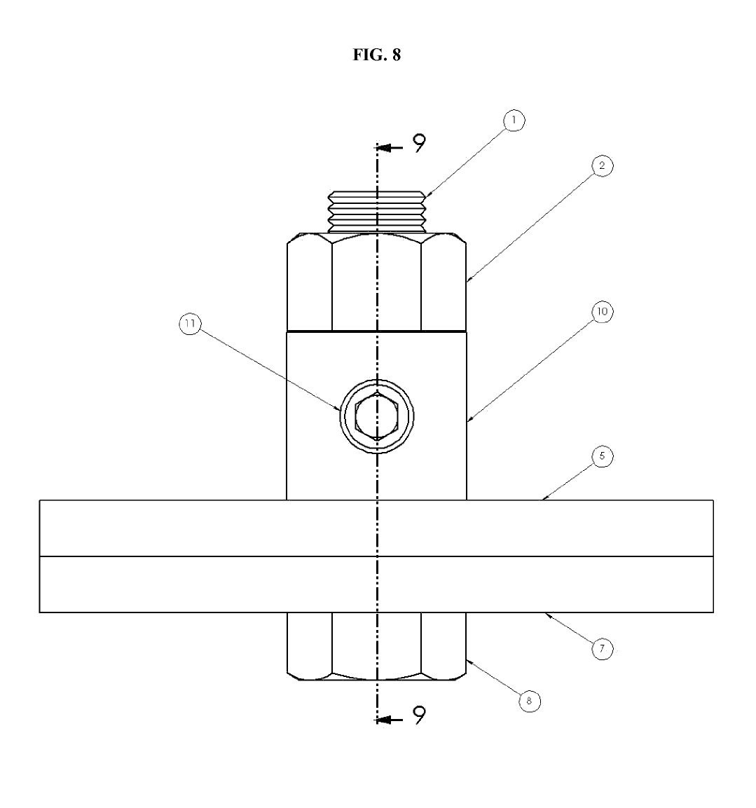

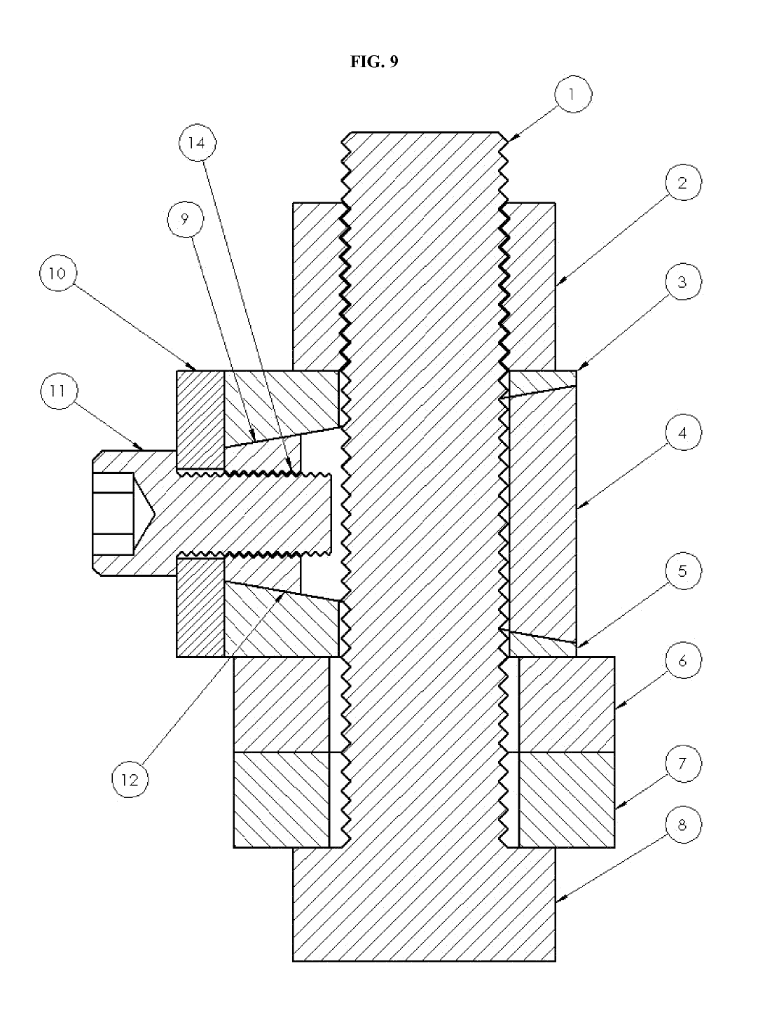

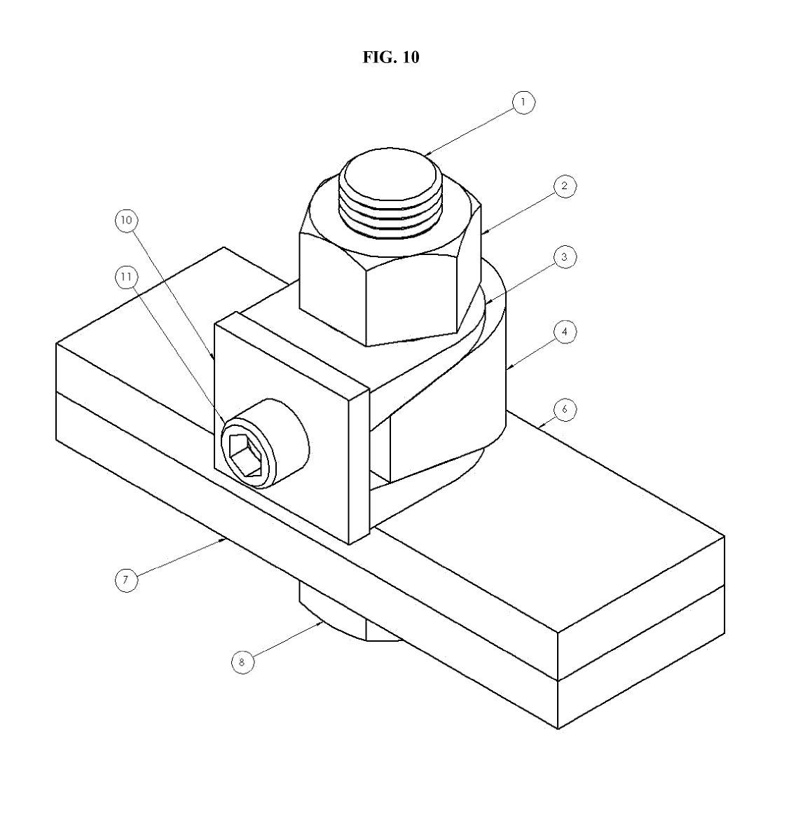

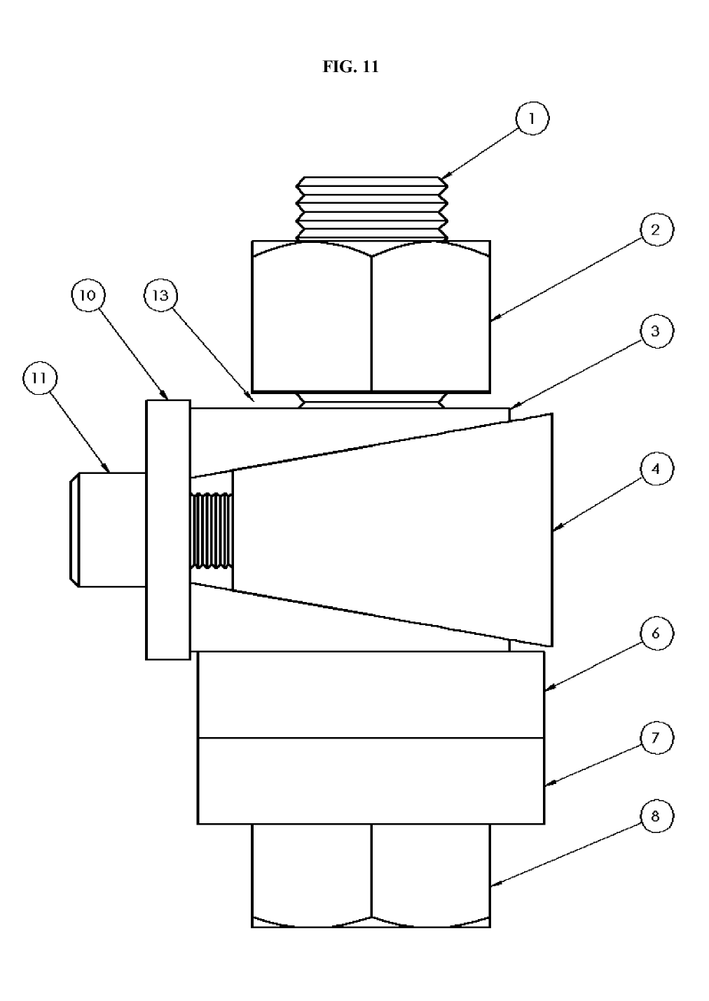

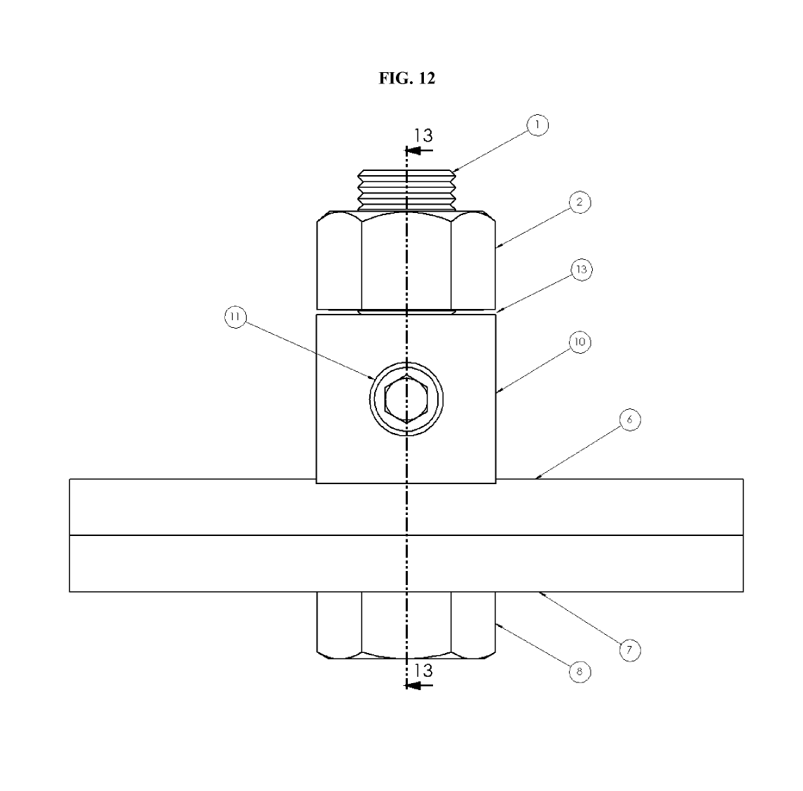

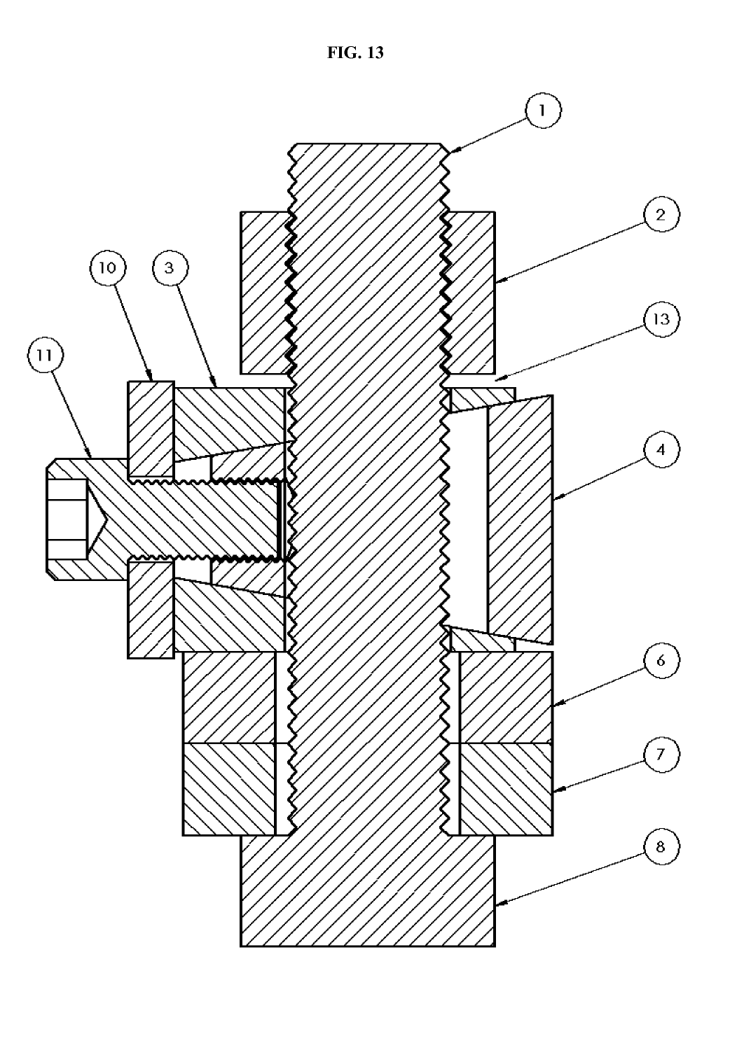

In accordance with the present invention, there is provided a tension relief system for threaded fasteners (FIGS. 1 to 15) comprising an upper wedge (3), a wedge-shaped inner body (4), a lower wedge (5), an outer body (10), a top sliding plane (9) created by the interface of the upper wedge (3) and the inner body (4), a bottom sliding plane (12) created by the interface of the lower wedge (5) and the inner body (4), and a restraining bolt (11). The restraining bolt (11) passes through the outer body (10) and engages the inner body (4) via the threaded hole (14) of the inner body. The upper wedge (3) also includes a hole (16) extending through the body through which a main bolt or stud may pass.

The skilled addressee will readily understand that depending on the use and final location of the tension relief system, different types of restraining bolts (11) could be used. Machine screws, power screws, socket-head cap screws, hex-head cap screws, security screws, locking screws, fully threaded screws, and partially threaded screws are all contemplated.

Also, it is to be understood that even though an integrated threaded hole (14) has been shown, the use of other types of mating techniques between the restraining bolt (11) and the inner body (4) are also contemplated. For example, the mating of the restraining bolt (11) with the inner body (4) could be effected with a normal threaded nut which is threaded on a restraining bolt (11) until it abuts on and mates with the inner body (4). Alternatively, a threaded nut could be embedded in the inner body (4). Therefore, the present invention is not limited to a particular mating technique between the restraining bolt (11) and the inner body (4).

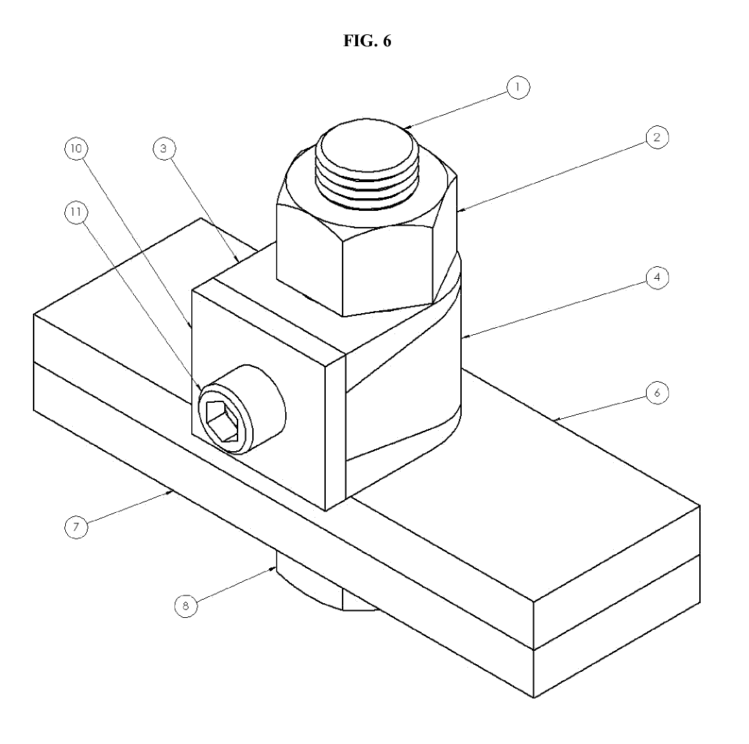

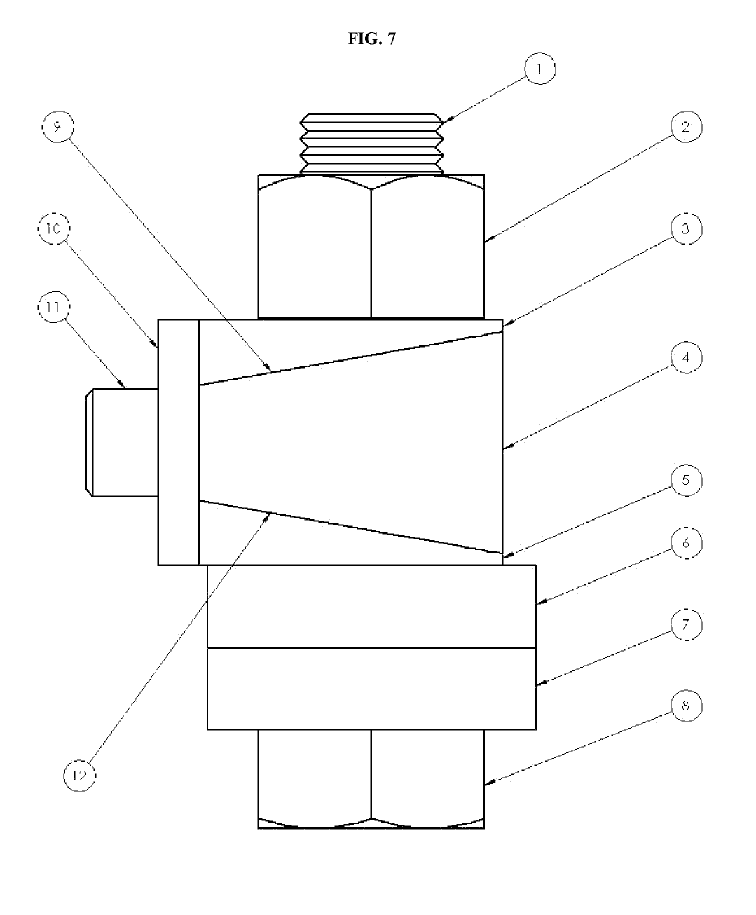

A first embodiment of the present invention is best shown in FIGS. 6 to 13. Its components comprise a restraining bolt (11) which passes through an outer body (10) and engages an inner body (4) via the threaded hole (14) of the inner body, thereby inhibiting relative movement of the outer body (10) and the inner body (4). The embodiment is further comprised of an upper wedge (3) and a lower wedge (5) which are situated against the outer body (10) and the inner body (4). Said orientation creates a top sliding plane (9) at the interface of the upper wedge (3) and the inner body (4), and a bottom sliding plane (12) at the interface of the lower wedge (5) and the inner body (4). A main stud (1) or bolt with nut passes through the upper wedge (3), the inner body (4), and the lower wedge (5). The stud (1) can pass through holes in the two work pieces (6, 7) wherein the stud (1) can have an integral hex head (8) (see FIGS. 7, 8, 9, and 13) to allow it to be turned into place using external means, such as a hex socket. Alternatively, the stud can pass through holes in the two work pieces (6, 7) and thread into a standard nut under the bottom work piece (7), or the stud (1) can be threaded into the bottom work piece (7).

The tensile load in the main bolt (1) clamps the tension relief system and the work pieces together, thereby making the tension relief system part of the bolted assembly. The nut (2) bears down on the upper wedge (3), and the top work piece (6) similarly compresses the lower wedge (5). However, relative movement of the upper wedge (3) and the lower wedge (5) towards each other is inhibited by the outer body (10) and the inner body (4) which are anchored together by the restraining bolt (11); thus, the tensile load in the main bolt (1) is partially transferred to the restraining bolt (11). The wedge-like shape of the inner body (4) and the complimentary sloped features of the upper wedge (3) and lower wedge (5) result in a lower tensile load on the restraining bolt (11) compared to the main bolt (1). Said reduced tensile load can also result in a lower torque requirement for the restraining bolt (11) compared to the main bolt (1).

To activate the tension relief system, the restraining bolt (11) is loosened, allowing the inner body (4) to move away from the outer body (10) by sliding along the top sliding plane (9) and the bottom sliding plane (12). This, in turn, allows the upper wedge (3) and the lower wedge (5) to move towards each other. As the overall thickness of the bolted assembly is reduced, bolt stretch of the main stud (1) is alleviated and the tensile load lessens. If necessary, the height of the bolted assembly can be reduced past the point of removing stretch of the main stud (1), thereby creating a gap (13) between the nut (2) and the upper wedge (3). The reduction of the tensile load in the bolt (1) corresponds to a reduction in the forces on the threaded features of the nut (2) and the main bolt (1); thus, the bolted assembly may be disassembled with minimal risk of galling.

It is to be understood that even though a stud (1) with an integral head has been shown, the use of other types of studs and other types of mating techniques between the studs and work pieces (6, 7) are also contemplated. For example, the mating of the stud (1) with the lower work piece (7) could be effected with a normal threaded nut which is threaded on a stud until it abuts on and mates with the lower work piece (7). Therefore, the present invention is not limited to a particular mating technique between the stud (1) and work pieces (6, 7).

Also, it is to be understood that even though a flat outer body (10) has been shown, the use of other shapes of the outer body are considered. For example, the outer body could be wedge-shaped, sloped, cylindrical, concave, or convex. Therefore, the present invention is not limited to a particular shape of the outer body (10).

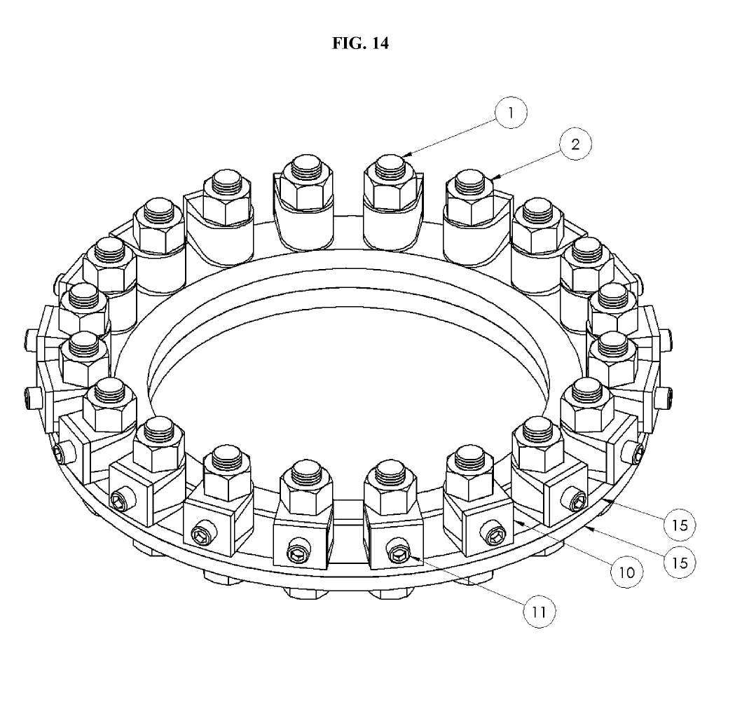

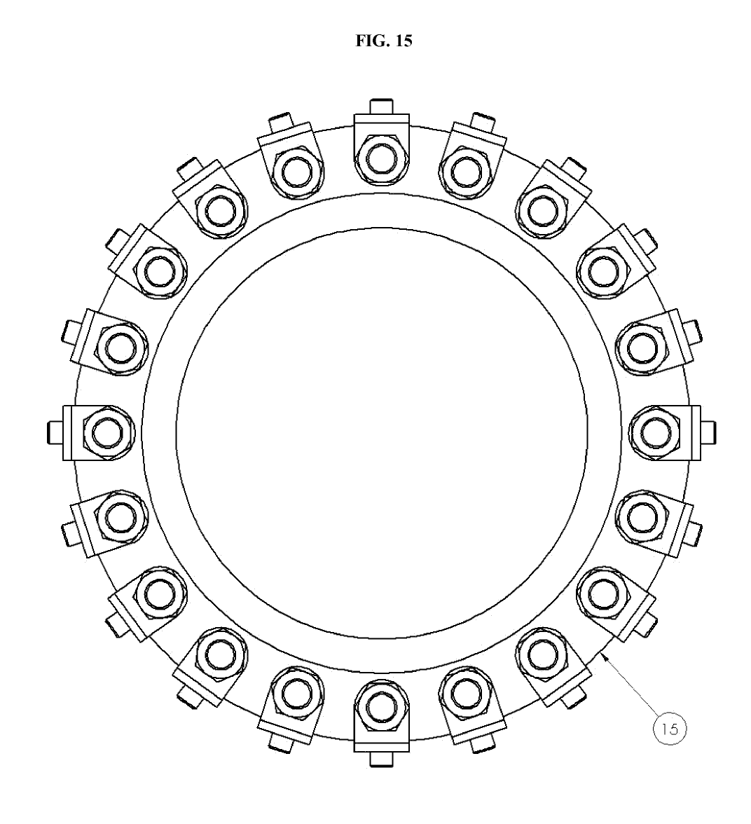

In another embodiment, multiple instances of the present invention are shown installed on the face of a circular flange (FIGS. 14 to 15). The stud bolts (1) are inserted through the upper wedge (3), the inner body (4), the lower wedge (5), and the corresponding flanges (15) that are mating together.

Obviously, even if only one shape of tension relief system has been shown and described, the skilled addressee will understand that the upper wedge (3), inner body (4), lower wedge (5), and outer body (10) of the present invention could be provided in a variety of shapes and sizes according to the specific needs of a specific bolted assembly.

Thus, although preferred embodiments of the invention have been described in detail herein and illustrated in the accompanying figures, it is to be understood that the invention is not limited to these precise embodiments and that various changes and modifications may be effected therein without departing from the scope or spirit of the present invention.

The invention claimed is:

1. A tension relief system for aiding in the disassembly of bolted assemblies, said tension relief system comprising:
a. an inner body having substantially sloped faces;
b. an outer body;
c. a restraining bolt, wherein said restraining bolt mates with said inner body thereby anchoring said inner body with said outer body and selectively restricting or promoting relative movement of said inner body compared to said outer body;
d. an upper body with a substantially wedge-like shape, wherein the sloped face of said upper body rests upon, and can slide along, one of said sloped faces of said inner body, until inhibited by said outer body such that lateral movement of said inner body relative to said outer body permits or results in a transverse movement of said upper body in a direction perpendicular to said movement of said outer body, thereby altering the overall length of said tension relief system in the aforementioned transverse direction;
e. a lower body with a substantially wedge-like shape, wherein the sloped face of said lower body rests upon, and can slide along, one of said sloped faces of said inner body, until inhibited by said outer body such that lateral movement of said inner body relative to said outer body permits or results in a transverse movement of said lower body in a direction perpendicular to said movement of said outer body, thereby altering the overall length of said tension relief system in the aforementioned transverse direction.

2. A tension relief system as claimed in claim 1, wherein said restraining bolt is a machine screw.

3. A tension relief system as claimed in claim 1, wherein said restraining bolt is a cap screw.

4. A tension relief system as claimed in claim 1, wherein said restraining bolt is a motorized screw.

5. A tension relief system as claimed in claim 1, wherein said inner body is a curved structure.

6. A tension relief system as claimed in claim 1, wherein said outer body is a curved structure.

7. A tension relief system as claimed in claim 1, wherein said upper body is a curved structure.

8. A tension relief system as claimed in claim 1, wherein said lower body is a curved structure.

9. A tension relief system as claimed in claim 1, wherein said inner body further comprises an alignment groove located on one or more of its faces.

10. A tension relief system as claimed in claim 1, wherein said outer body further comprises an alignment groove located on one or more of its faces.

11. A tension relief system as claimed in claim 1, wherein said upper body further comprises an alignment groove located on one or more of its faces.

12. A tension relief system as claimed in claim 1, wherein said lower body further comprises an alignment groove located on one or more of its faces.
